(19) United States
(12) Patent Application Publication
(10) Pub. No.: US 2004/0105729 A1
(43) Pub. Date: Jun. 3, 2004

(54) Drilling or milling tool and process for its manufacture

(75) Inventors: Josef Giessler, Muhlenbach (DE); Jonas Svensson, Offenburg (DE)

Correspondence Address: BURNS DOANE SWECKER & MATHIS L L P, POST OFFICE BOX 1404, ALEXANDRIA, VA, 22313-1404, US

(73) Assignee: SANDVIK AB, SANDVIKEN (SE)

(21) Appl. No.: 10/642,343

(22) Filed: Aug. 18, 2003

(30) Foreign Application Priority Data
Aug. 16, 2002 (DE) 102 38 334.0

(51) Int. Cl. B23C 5/10

(52) U.S. Cl. 407/53

(57) ABSTRACT

A rotary cutting tool includes a cutting part having helical grooves formed in an outer periphery thereof. Each groove forms a helix angle relative to the axis of rotation which gradually transforms into a smaller cutting face angle at a front end of the cutting action.

This application claims priority under 35 U.S.C. §§ 119 and/or 365 to Patent Application Serial No. 102 38 334.0 filed in Germany on Aug. 16, 2002, the entire content of which is hereby incorporated by reference.

### BACKGROUND OF THE INVENTION

The present invention relates to a drilling or milling tool with a shank and a cutting part, the cutting part having cutting grooves running helically along its periphery and extending to the end face of the cutting part and also having, at its end face, cutting edges which are formed where the cutting-grooves intersect the end face of the tool, wherein the helix angle of the cutting grooves, measured relative to a plane containing the tool axis, is greater than the angle, measured at a corresponding plane, of the cutting faces adjoining the end-face cutting edges.

Corresponding drilling or milling tools have already been known for some time. In particular, drills or milling cutters which consist of particularly hard materials, such as e.g. cemented carbide, boron nitride, silicon nitride or mixtures of these, are to a greater or lesser extent in danger of breaking in the area of the end-face cutting edges. It is to be noted that some materials also unfortunately become increasingly more fragile as their hardness or wear resistance increases. Although a variety of manufacturing methods have already been successfully used in recent years to make suitable hard substances tougher so that they break less easily, these improvements are counteracted by increasing requirements with respect to the geometry of the cutting edges.

Thus, drills or also face milling cutters, which consist of a solid hard substance, such as e.g. tungsten carbide or one of the above-named hard materials, have now already been in existence for a relatively long time. In the case of corresponding tools which have helically-running grooves, the cutting angle of the end-face cutting edges is defined essentially by the helix angle of the cutting grooves. This is because the cutting edges are formed by the intersection between the cutting groove and the end face of the tool.

In the grinding process for the manufacture of such a drilling or milling tool which has a shank and an essentially cylindrical cutting part, the cutting grooves are ground helically into the cutting part with the help of a rotating abrasive disc, which is inclined to the axis of the tool, during relative axial movement between the abrasive disc and the tool and with a simultaneous rotation of the cutting piece about its axis. Alternatively, if cutting grooves have already been preformed during the manufacture or sintering, the cutting grooves are completed and reground by this grinding process.

As the cutting edge is formed essentially by the wall of the cutting groove, which is manufactured by a flat, even part of the abrasive disc, and the axis of the abrasive disc is inclined relative to the axis of the cutting part precisely below the complementary angle to the helix angle, an inclination to a plane containing the axis of the tool is produced for this section of the cutting-groove face, in order to achieve precisely the desired helix angle. Since that cutting-groove face continues to the end face of the tool, that part of the cutting-groove face finally also forms the cutting face which is inclined in a corresponding manner to the axis of the tool. If an axial advance of the tool is disregarded, which is incidentally not excessive per rotation even in the case of drills, the helix angle corresponds precisely to the cutting angle of the end-face cutting edge. Variations of this cutting angle in the radial direction, which must necessarily occur nearer to the center or the axis of the cutting tool due to the steeper spiral pattern of the cutting grooves, initially remain disregarded.

In order to achieve low cutting forces, it is desirable to make the cutting angle as large as possible. However, this leads to an increasingly smaller wedge angle between the cutting face and the free space, so that even in profile the cutting edge also appears ever more sharp-edged or ever more acute, while however also being exposed to an increased danger of breaking. On the other hand, the large helix angle of the cutting grooves also contributes to an improved carrying away of material chips and is therefore also desired for this reason.

It has already been attempted to eliminate the problems of susceptibility to breaking that result from a large helix angle by “breaking” the cutting edge, i.e. grinding a chamfer which makes the cutting edge less sharp-edged. The thus-formed face of the chamfer defines the cutting-face area directly adjoining the cutting edge and therefore forms a cutting face which has a considerably smaller (positive) cutting angle.

However, such a chamfer is relatively costly and laborious to manufacture because, after the manufacture of the cutting grooves, the tool must be machined once more in a new work step with a suitable grinding tool which produces the chamfering at the cutting edge.

It is also disadvantageous that, through the chamfering of the cutting edge, the resulting cutting forces are again considerably increased.

Compared with this state of the art, the object of the present invention is to create a drilling or milling tool as well as a process for its manufacture, which has low cutting forces and nevertheless provides a large helix angle in order to produce a good material transport and favourable cutting ratios.

### SUMMARY OF INVENTION

As regards the initially mentioned drilling or milling tool, the object of the invention is achieved in that the cutting-face angle, starting from the end-face cutting edge, continuously changes into the helix angle of the cutting grooves.

As already mentioned, the cutting angle is the angle formed between the cutting face and a perpendicular relative to a surface generated in the workpiece. As the generated surface corresponds essentially to the end face of the tool, a perpendicular to the cutting edge corresponds essentially to the tool axis, wherein, even in the case of a more or less conical end face, the cutting angle is measured relative to a plane containing the axis and in a plane running parallel to the axis. A numerical value changing continuously from a smaller cutting-angle value into the value of the helix angle then corresponds to a cutting groove running continuously more steeply towards the tip or at least to the groove face which, with the end face, defines a cutting edge.

In other words, the characterizing feature of the invention could also be formulated such that, in the end area of the tool, the helix angle relative to the end face of the drill becomes continuously smaller.

As regards the corresponding manufacturing process, the object of the invention is achieved in that when the active area of the abrasive disc approaches the end face of the tool, the axis of the abrasive disc is continuously tilted (still further) in the direction generating a smaller helix angle. The abrasive disc is a flat disc rounded at its outer periphery, the thickness of which corresponds to the maximum width of the cutting groove and the rounded outer periphery of which corresponds in profile to the profile of the cutting groove. The axis of the disc is inclined relative to the axis of the tool at an angle which corresponds to the complementary angle relative to the helix angle. If the helix angle is therefore designated γₚ₂ then the axis of the abrasive disc has an inclination of 90°-γₚ₂ relative to the axis of the tool. An increase in the angle between the abrasive-disc axis and the tool axis therefore means a reduction in the helix angle, so that ultimately if the active area of the abrasive disc grinds the axial end section of the cutting groove, the minimum helix angle is achieved which then also corresponds to the cutting angle γₚ₀.

It is also possible to reduce the cutting angle γₚ₀ to the value zero, or even to make it negative by tilting the axis of the abrasive disc, when the working area approaches the end face of the tool by 90° and more, vis-à-vis the axis of the tool.

Furthermore, it is possible to change, in particular to increase, the ratio of the axial relative velocity between the abrasive disc and the tool and of the angular velocity during the rotation of the tool about its own axis when approaching the end face of the tool, while the tilting of the abrasive-disc axis takes place at a continuous speed. Instead of this, however, the tilting could also initially be somewhat slower or somewhat faster or vice versa, as a result of which there are produced quite specific, desired profiles of the continuous transition between the cutting angle and the helix angle. According to the invention, a tool is preferred in which the transition from the cutting angle to the helix angle, starting from the cutting edge, initially takes place with a relatively small transition radius, while the last section of the transition to the helix angle takes place over a larger radius of curvature. The curvature of the transition area has a direction which incidentally corresponds to the direction of the abrasive-disc axis and the direction of which inasmuch forms the complementary angle to the helix angle or cutting angle which is in each case current. The radius of that curvature can also continuously change during the transition from the cutting angle at the cutting edge into the constant helix angle lying axially further inward.

The axial extension of this transition area corresponds at the very most to the diameter of the tool and is preferably less than half the diameter of the tool. If a chamfering or a rounding of this corner area is provided in the outer corner area during the transition from the end face to the peripheral surface of the cutting part, the gradual transition from the cutting angle to the helix angle extends over at least the same axial length.

### BRIEF DESCRIPTION OF THE DRAWINGS

Further advantages, features and possible applications of the present invention become clear with reference to the following description of a preferred version and the associated figures.

FIG. 1: a side view of a tool according to the invention in the form of a face milling cutter.

FIG. 2: the top view of the end face of the milling cutter represented in FIG. 1.

FIG. 3a: an enlarged section cut from the lower area of the cutting part according to FIG. 1.

FIG. 3b: an enlarged section of a first embodiment cut from the pattern of the cutting edge 5 in the end area of the milling cutter.

FIG. 3c: an enlarged section of a second embodiment cut from the pattern of the cutting edge 5 in the end area of the milling cutter.

### DESCRIPTION OF PREFERRED EMBODIMENTS OF THE INVENTION

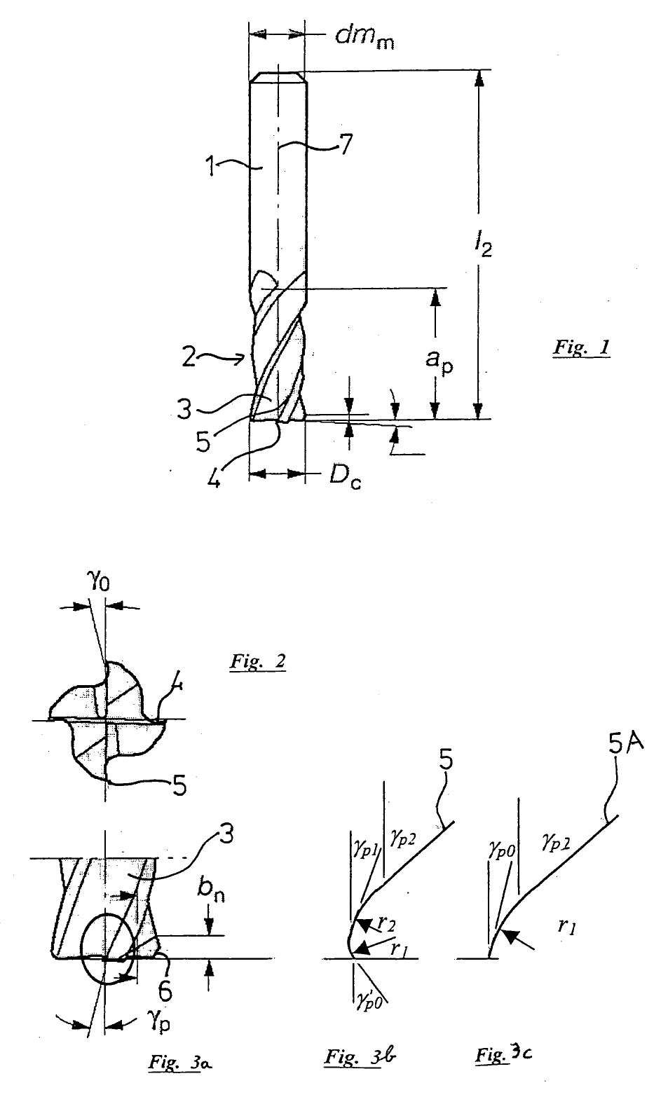

There can be seen in FIG. 1, a face milling cutter with a shank 1 for clamping into a corresponding tool machine and with a cutting part 2 which has several helical grooves 3, a front end face with essentially radially-running end-face (front) cutting edges 4 and, at the periphery of the milling cutter, helical cutting edges 5 running parallel to the cutting grooves. The cutting grooves 3 are produced by inclining a flat abrasive disc (the thickness of which corresponds to the width of the cutting grooves 3) relative to the axis 7 of the milling cutter, in order to grind the grooves into the cylindrical wall of the cutting part. An axial relative movement between the abrasive disc and the milling cutter takes place during this grinding process and simultaneously the milling tool is rotated about the axis 7. The ratio of the axial velocity to the rotational velocity of the milling cutter then determines the helix angle of the grooves 3 and is generally adjusted such that the axis of the abrasive disc forms, with the axis 7 of the tool, an angle which is complementary relative to the helix angle γₚ₂. The cutting lines between the cutting grooves and the outer periphery of the tool form cutting edges, i.e., the main cutting edges 5 at the periphery of the originally cylindrical cutting part 2 and the secondary cutting edges 4 at the end face.

The conditions are similar in the case of a drilling tool, wherein however, in the case of a drill, the cutting edges 4 would be the main cutting edges, while the cutting edges 5 provided at the periphery would be designated secondary cutting edges.

The helix angle is generally the angle which the cutting edges 5 form with a plane P containing the axis 7. In a bend in a plane, an essentially straight pattern of the cutting edge would result and the helix angle then corresponds to the angle to the vertical.

In the front end view of the end face of the milling cutter according to FIG. 2, it can be seen that the milling cutter has four cutting grooves and four helical cutting edges 5 as well as four radial cutting edges 4 on the end face. The cutting edges 5 have a lateral cutting angle γ₀ formed between the wall of the respective groove and the plane P which intersects the cutting edge 5 (as shown in FIG. 2) and which is generally positive like the cutting angle of the secondary cutting edges 4.

The present invention relates above all to the design of the radial cutting edges 4 or to the cutting faces located at the cutting edges 4. This pattern is shown more precisely in FIGS. 3a-3c. FIG. 3a shows the lower section of the milling cutter represented in FIG. 1, wherein a chamfering 6 of the outer corner transitions between the end face and the peripheral surface of the milling cutter. In FIGS. 3b and 3c, the lower end section of the main cutting edges 5, 5A is represented for two different embodiments respectively, in a view corresponding to the encircled area of FIG. 3a. As can be seen, the main cutting edge 5, 5A runs inclined to the axis 7 of the milling cutter at an angle δₚ₂ which, as already mentioned, is designated the helix angle. If the main cutting edge 5, 5A ran in a continuous, unchanged pattern to the end face of the drill, this helix angle γₚ₂ would simultaneously also correspond to the cutting angle of the secondary cutting edge 4. However, as can be seen however in FIGS. 3b and 3c, the main cutting edge 5, 5A runs increasingly more steeply towards the end face of the milling cutter on a curved bend and in FIG. 3c the main cutting edge 5A actually attains a minimum (positive) value γₚ₀. In the case of FIG. 3b, the main cutting edge 5 attains a minimum (negative) value γ′ₚ₀. In FIG. 3c, the transition from the helix angle γₚ₂ to the cutting angle γₚ₀ of the main cutting edge 5A runs along a constant radius R1. In the case of FIG. 3b, two transition radii R2 and R1 are provided, radius R1 at the lowest end of the main cutting edge 5 being smaller than radius R2.

However, there are also variants and versions in which, starting from the cutting edge 4, the cutting angle, or more precisely the changing angle of the cutting face, initially increases only gradually relative to the milling cutter axis along a relatively large radius (relative to the curve of the main cutting edge 5) and then has a smaller transition radius to the helix angle γₚ₂.

The tool according to the invention combines the positive properties of tools with a large helix angle and a clearly positive secondary cutting edge with the stability of a tool with a less positive and optionally even negative cutting edge. In addition, the tool has the advantage of a relatively easy and rapid manufacture, because the transition from the larger helix angle to the smaller cutting angle is effected simultaneously with the production of the cutting grooves by tilting the axis of the abrasive disc in a program-controlled manner during the final section of the grinding process so that, depending on the program set, the desired contour and in any case a gradual transition from the helix angle to the final cutting angle results.

Although the present invention has been described in connection with preferred embodiments thereof, it will be appreciated by those skilled in the art that additions, substitutions, modifications and deletions may be made without departing from the spirit and scope of the invention as defined in the appended claims.

What is claimed is:

1. Rotary cutting tool comprising a shank and a cutting part disposed at a front end of the shank and defining an axis of rotation; an outer periphery of the cutting part therein cutting grooves extending helically to a front end face of the cutting part; the end face including end-face cutting edges formed by an intersection of the end face with respective walls of the grooves; wherein a portion of each cutting groove disposed rearwardly of the end face defining a helix angle with a plane containing the axis, the helix angle being larger than a cutting-face angle formed between the end face and a front end section of each cutting groove; the cutting-face angle continuously transforming into the helix angle.

2. The rotary cutting tool according to claim 1 wherein the cutting-face angle transforms into the helix angle along a constant radius of curvature.

3. The rotary cutting tool according to claim 1 wherein the cutting-face angle transforms into the helix angle along a plurality of radii, including a first radius adjoining the cutting edge, and a second radius adjoining the helix angle, the first radius being smaller than the second radius.

4. The rotary cutting tool according to claim 3 wherein the cutting-face angle has a negative value, and each groove forming a zero-degree angle and then a positive angle while transforming into the helical angle.

5. The rotary cutting tool according to claim 1 wherein a transition between the cutting-face angle and the helix angle extends substantially parallel to the axis for a distance shorter than a diameter of the tool.

6. The cutting tool according to claim 5 wherein a transition between the cutting-face angle and the helix angle extends substantially parallel to the axis for a distance shorter than one-half a diameter of the tool.

7. The rotary cutting tool according to claim 1 wherein the end face and the outer periphery are joined by a chamfer, the chamfer having an axial extension shorter than an axial extension of a transition from the cutting-face angle to the helix angle.

8. The rotary cutting tool according to claim 1, wherein a wall of each cutting groove forms a lateral angle with a plane containing the axis and passing through the cutting edge of such cutting grooves; the cutting-face angle of such cutting groove being equal to the lateral angle.

9. The rotary cutting tool according to claim 1 comprising a drilling tool.

10. The rotary cutting tool according to claim 1 comprising a milling tool.

11. A process for the manufacture of a rotary cutting tool, the rotary cutting tool comprising a shank and a cutting part disposed at a front end of the shank and defining a first axis of rotation; the process comprising shaping a helical groove in an outer periphery of the cutting part by the steps of:
A) rotating an abrasive disc about a second axis of rotation;
B) engaging the rotating disc against the outer periphery of the cutting part at a location rearwardly of a front end face of the cutting part with the first axis inclined relative to the front axis;
C) rotating the cutting part about the first axis during step B;
D) producing relative axial movement between the disc and the cutting part in a direction parallel to the first axis during steps B and
C whereby the disc approaches the front end face, along a helix angle; and
E) tilting the disc continuously when the disc reaches a position adjacent the front end face, wherein the groove forms a continuously reducing helix angle toward the front end face.

12. The process according to claim 11 wherein the abrasive disc forms the helical groove during steps A-E.

13. The process according to claim 11 wherein the abrasive disc finishes a preformed groove during steps A-E.

14. The process according to claim 11 wherein a ratio between the relative axial movement and the rotational velocity of the cutting part has a first value during steps A-D, and a second value during step E, wherein the second value is greater than the first value.
